(19) United States
(12) Patent Application Publication
(10) Pub. No.: US 2008/0033328 A1
(43) Pub. Date: Feb. 7, 2008

(54) Mask assembly for massage chairs

(76) Inventor: Horng-Jiun Chang, Changhua County (TW)

Correspondence Address: CHANG, Horng-Jiun, P.O. Box 44-2049, Taipei, 10668, omitted

(21) Appl. No.: 11/497,396

(22) Filed: Aug. 2, 2006

(51) Int. Cl. A61H 7/00; A61H 19/00

(52) U.S. Cl. 601/99

(57) ABSTRACT

A mask assembly for massage chairs includes a first part connected to the backrest of the massage chair and including a front opening and a concaved space which is in communication with the front opening and accommodates the user's head. A second part is pivotably connected to the first part and can be pivoted to cover the front opening of the first part. The first and/or second parts can be equipped with audio device and/or and an a-ray emitting device.

### BACKGROUND OF THE INVENTION

(1) FIELD OF THE INVENTION

The present invention relates to a mask assembly for massage chairs and the mask assembly has an a-ray bulb for improving blood circulation of the user's eyes.

(2) DESCRIPTION OF THE PRIOR ART

A conventional massage chair generally includes a seat portion, a back rest, two arm rests and a leg rest. Each of the seat portion, the back rest, the two arm rests and the leg rest has at least one massage mechanism received therein so that the user can enjoy massage from shoulder to legs. However, when the user lies in the massage chair, the user's head is exposed to the noise and/or light which might bother the user and the user cannot be relax during using the massage chair.

The present invention intends to provide a mask assembly for a massage chair wherein the mask assembly covers the user's face to avoid the light from bothering the user's eyes.

### SUMMARY OF THE INVENTION

The present invention relates to a mask assembly for massage chairs which includes a seat portion, a back rest, two arm rests and a leg rest. The mask assembly comprises a first part connected to the backrest of the massage chair and including a front opening and a concaved space which is in communication with the front opening and accommodates the user's head. A second part is pivotably connected to the first part and able to pivotably cover the front opening of the first part.

The primary object of the present invention is to provide a mask assembly for a massage chair wherein the user's head can be enclosed by the mask assembly to avoid light or noise from outside.

Another object of the present invention is to provide a mask assembly for a massage chair wherein an a-ray emitting device is equipped in the mask assembly so as to improve the blood circulation of the user's eyes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the massage chair and the mask assembly of the present invention;

FIG. 2 is an exploded view to show the mask assembly of the present invention;

FIG. 3 is a side view to show the massage chair and the mask assembly of the present invention, and

FIG. 4 shows that the back rest of the massage chair is pivoted backward and the second part of the mask assembly is pivoted toward the first part of the mask assembly.

### DETAILED DESCRIPTION OF THE PREFERRED EMBODIMENT

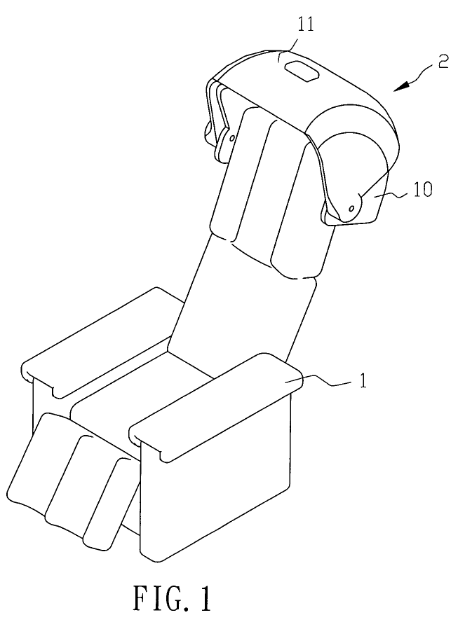

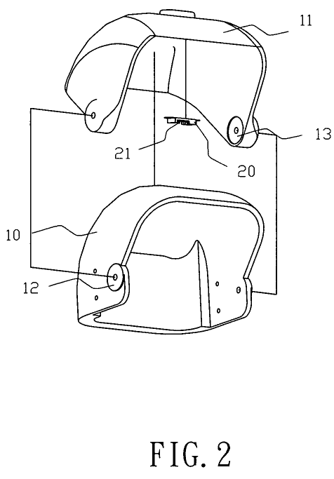

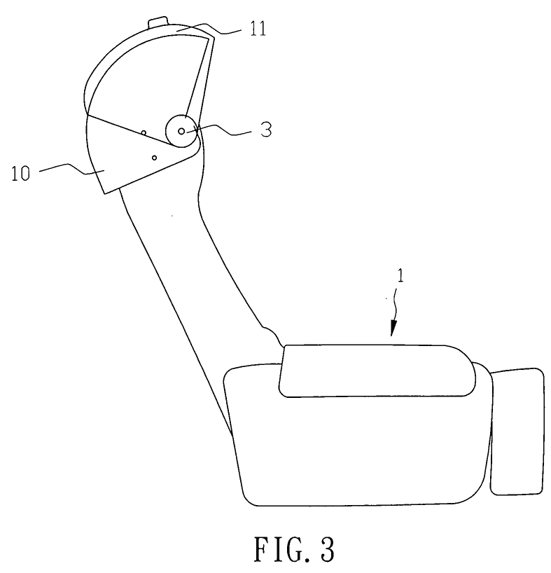

Referring to FIGS. 1 to 4, the massage chair 1 includes a seat portion, a back rest, two arm rests and a leg rest. The mask assembly of the present invention comprises a first part 10 which includes two sidewalls and the two sidewalls are connected to two outsides of a top portion of the back rest. A protrusion 12 extends from an outside of each of the sidewalls of the first part 10. The first part 10 further includes a front opening and a concaved space which is in communication with the front opening and accommodates the user's head (not shown).

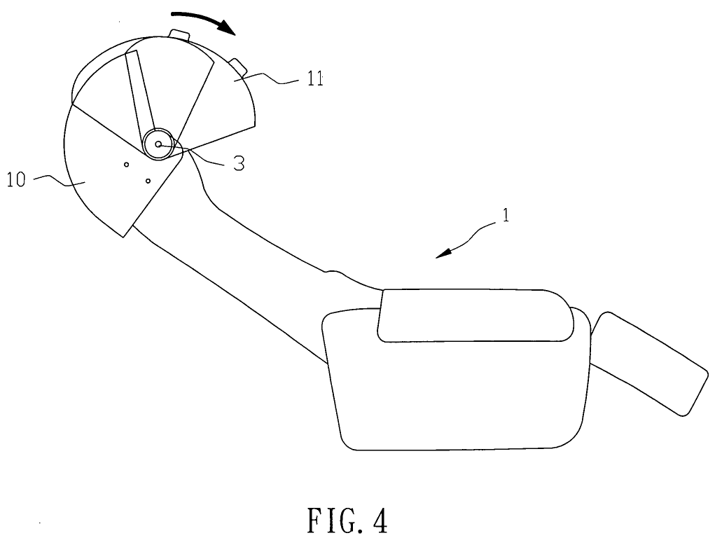

A second part 20 has two recesses 13 defined in two opposite insides of the second part 11 and the two protrusions 12 are pivotably engaged with the two recesses 13 so that the second part 20 is pivotably connected to the first part 10. The second part 20 can be pivotable about the two protrusions 12 to cover the front opening of the first part 10. In other words, the user's face can be covered by the mask assembly. An α-ray emitting device 20 including an α-ray bulb 21 are connected to an inside of the second part 11 so that when the user lies in the massage chair 1 as shown in FIG. 4, the α-ray bulb 21 emits α-rays to improve blood circulation of the user's eyes.

The area that the first part 10 covers is larger than the area that the second part 11 can cover, so that the user's head can be comfortably received in the first part 10 and the second part 11 can be pivoted to cover the front opening of the first part 10 to completely enclose the user's head in the mask assembly. The mask assembly may be equipped with audio device as desired.

While we have shown and described the embodiment in accordance with the present invention, it should be clear to those skilled in the art that further embodiments may be made without departing from the scope of the present invention.

What is claimed is:

1. A mask assembly for massage chairs which includes a seat portion, a back rest, two arm rests and a leg rest, the mask assembly comprising:
a first part adapted to be connected to the backrest of the massage chair and including a front opening and a concaved space which is in communication with the front opening and adapted to accommodate the user's head, the first part, and a second part pivotably connected to the first part and pivotably covering the front opening of the first part.

2. The assembly as claimed in claim 1, wherein the first part includes two sidewalls which are adapted to be connected to two outsides of a top portion of the back rest.

3. The assembly as claimed in claim 1, wherein an a-ray emitting device including an a-ray bulb are connected to an inside of the second part.

4. The assembly as claimed in claim 2, wherein the two sidewalls of the first part each have a protrusion extending from an outside thereof and two recesses are defined in two opposite insides of the second part, the two protrusions are pivotably engaged with the two recesses.
